(19) United States
(12) Patent Application Publication
(10) Pub. No.: US 2014/0021402 A1
(43) Pub. Date: Jan. 23, 2014

(54) METHOD FOR PRODUCING ANODE ACTIVE MATERIAL, AND ANODE ACTIVE MATERIAL

(71) Applicants: Seiichi TARUTA, Nagano City (JP); Hiroyuki YAMAGUCHI, Susono-shi (JP); Shin USHIRODA, Susono-shi (JP)

(72) Inventors: Seiichi TARUTA, Nagano City (JP); Hiroyuki YAMAGUCHI, Susono-shi (JP); Shin USHIRODA, Susono-shi (JP)

(73) Assignees: TOYOTA JIDOSHA KABUSHIKI KAISHA, Toyota-shi (JP); SHINSHU UNIVERSITY, Matsumoto City (JP)

(21) Appl. No.: 13/944,324

(22) Filed: Jul. 17, 2013

(30) Foreign Application Priority Data
Jul. 18, 2012 (JP) 2012-159693

(51) Int. Cl. H01M 4/58; C01B 33/32

(52) U.S. Cl. CPC H01M 4/5825; C01B 33/32
USPC 252/182.1

(57) ABSTRACT

A main object of the present invention is to provide a method for producing, with excellent productivity, an anode active material having the composition of a mica group mineral. The object is attained by providing a method for producing a vitreous anode active material, comprising steps of: a heat treatment step of heat treating a raw material mixture having a composition that is capable of forming a mica group mineral, at a heat treatment temperature that is higher than or equal to the melting temperature of the raw material mixture, and thereby forming a raw material melt; and a cooling step of cooling the raw material melt and thereby vitrifying the raw material melt.

### TECHNICAL FIELD

The present invention relates to a method for producing, with excellent productivity, an anode active material having the composition of a mica group mineral.

### BACKGROUND ART

Along with the rapid distribution in recent years of information-related devices, communication devices and the like, such as personal computers, video cameras and mobile telephones, it has been considered important to develop batteries (for example, lithium batteries) that are excellent as power sources of those devices. Also, in the fields other than the fields of information-related devices and communication-related devices, for example, in automobile industry, the development of lithium batteries and the like that are used in electric cars or hybrid cars is in progress.

A battery such as a lithium battery usually comprises a cathode layer, an anode layer, and an electrolyte layer that is formed between the cathode layer and the anode layer. Furthermore, the anode layer usually contains an anode active material. For example, Patent Literature 1 discloses a lithium secondary battery which contains a mica group mineral having at least one transition metal in the composition, as an anode active material. Furthermore, Patent Literature 2 discloses a lithium secondary battery which uses a layered clay mineral as an anode material. Such minerals are resources that are abundant, and can sufficiently function as anode active materials even without being subjected to special processing treatments. Therefore, the minerals have advantages of being inexpensive and imposing less environmental load, and batteries exhibiting satisfactory battery characteristics can be formed therefrom.

### CITATION LIST

### Patent Literature

Patent Literature 1: Japanese Patent Application publication (JP-A) No. 2011-165642
Patent Literature 2: JP-A No. 2004-296370

### SUMMARY OF INVENTION

### Technical Problem

Mica group minerals usually have a layered crystal structure. Therefore, when synthesis of a compound having the same structure as that of mica group minerals is attempted, a crystallization process is required. Furthermore, there is a problem with the crystallization process that, for example, strict control of the conditions for burning is required in order to obtain a desired crystal structure, and productivity is lowered.

Under such circumstances, an object of the present invention is to provide a method for producing, with excellent productivity, an anode active material having the composition of a mica group mineral.

### Solution to Problem

In order to solve the problems described above, the inventors of the present invention conducted a thorough investigation on the minerals described above, and the inventors confirmed that insertion and desorption of conductive ions (for example, Li ions) can be achieved even in a vitreous compound having a composition such as that of the minerals described above, thus completing the present invention. That is, according to an aspect of the present invention, there is provided a method for producing a vitreous anode active material, the method comprising steps of: a heat treatment step of heat treating a raw material mixture having a composition that is capable of forming a mica group mineral to form a raw material melt; and a cooling step of cooling the raw material melt to vitrify the raw material melt.

According to the present invention, when a raw material mixture having a composition that is capable of forming a mica group mineral is heat treated to obtain a raw material melt, and then the raw material melt is cooled, a vitreous anode active material having the composition of a mica group mineral can be obtained. Furthermore, the present invention has an advantage that since the method of the invention does not include a crystallization process for which strict control is required, higher productivity is obtained as compared with the conventional synthesis of compounds having the compositions of mica group minerals.

According to an embodiment of the present invention, the raw material mixture is preferably such that an anode active material represented by a general formula: XY₃ZSi₃O₁₀A₂ can be formed from the raw material mixture, wherein the X element represents at least one of K, Na, Ca, Li and Sr; the Y element represents at least one of Mg, Fe(II), Al and Li; the Z element represents at least one of Si, Al, Fe(III), Ge, Ga and B; and the A element represents at least one of OH, F, Cl, O and S.

According to another embodiment of the invention, it is preferable that in the heat treatment process, the raw material mixture be mixed by a dry method and a wet method.

Furthermore, according to another embodiment of the invention, it is preferable that a temperature at which the raw material mixture is heat treated be 1100° C. or higher.

According to another aspect of the present invention, there is provided a vitreous anode active material represented by a general formula: XY₃ZSi₃O₁₀A₂, wherein the X element represents at least one of K, Na, Ca, Li and Sr; the Y element represents at least one of Mg, Fe(II), Al and Li; the Z element represents at least one of Si, Al, Fe(III), Ge, Ga and B; the A element represents at least one of OH, F, Cl, O and S.

According to the present invention, since the material has a composition represented by the general formula described above, is vitreous, and is capable of insertion and desorption of conductive ions (for example, Li ions), the anode active material can function as an anode active material.

### Advantageous Effects of Invention

According to the present invention, a vitreous anode active material having the composition of a mica group mineral can be produced, and an effect of excellent productivity is provided.

### BRIEF DESCRIPTION OF DRAWINGS

FIG. 1 is a flow chart illustrating an example of the method for producing an anode active material of the present invention;

FIG. 2 is a schematic diagram illustrating an example of the crystal structure of a mica group mineral;

FIG. 3 is a diagram showing the results of an X-ray diffraction (XRD) analysis of the anode active materials obtainable in Examples 1 to 4;

FIG. 4 is a diagram showing the results of a test for the initial charge-discharge properties of batteries for evaluation that use the anode active materials obtainable in Examples 3 and 4; and

FIG. 5 is a diagram showing the results of a test for the cycle characteristics of batteries for evaluation that use the anode active materials obtainable in Examples 3 and 4.

### DESCRIPTION OF EMBODIMENTS

Hereinafter, the method for producing an anode active material of the present invention and the anode active material of the present invention will be described in detail.

A. Method for Producing Anode Active Material

First, the method for producing an anode active material of the present invention will be explained. The method for producing an anode active material of the present invention is a method for producing a vitreous anode active material, and comprising steps of: a heat treatment step of heat treating a raw material mixture having a composition that is capable of forming a mica group mineral to form a raw material melt; and a cooling step of cooling the raw material melt to vitrify the raw material melt.

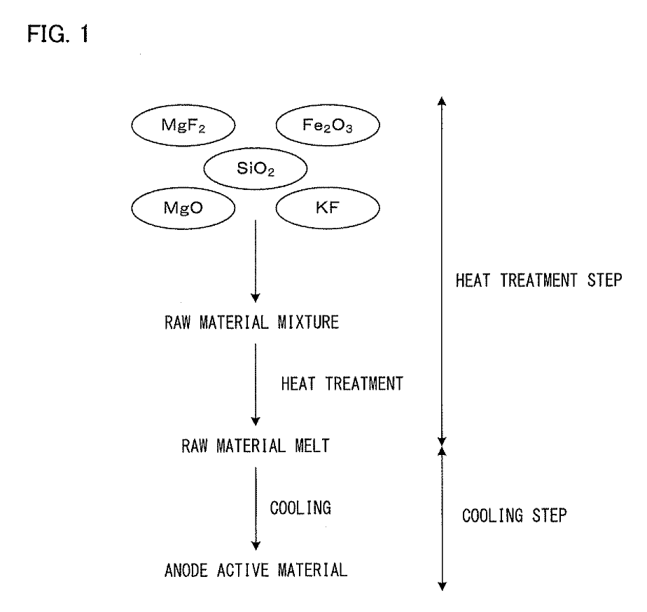

FIG. 1 is a flow chart illustrating an example of the method for producing an anode active material of the present invention, and specifically, an anode active material can be obtained through the following processes. That is, a raw material mixture having a composition that is capable of forming a mica group mineral is formed. Thereafter, the raw material mixture is subjected to a heat treatment at a heat treatment temperature higher than or equal to the melting temperature of the raw material mixture, and thus a raw material melt is formed (heat treatment step). Next, the raw material melt thus obtained is cooled, and thereby the raw material melt is vitrified (cooling step). As a result, a vitreous anode active material having the composition of a mica group mineral can be obtained.

According to the present invention, a vitreous anode active material having the composition of a mica group mineral can be obtained by heat treating a raw material mixture having a composition that is capable of forming a mica group mineral so as to obtain a raw material melt, and then cooling the raw material melt. Furthermore, the present invention has an advantage that since the method of the invention does not include a crystallization process for which strict control is required, higher productivity is obtained as compared with the conventional synthesis of compounds having the compositions of mica group minerals.

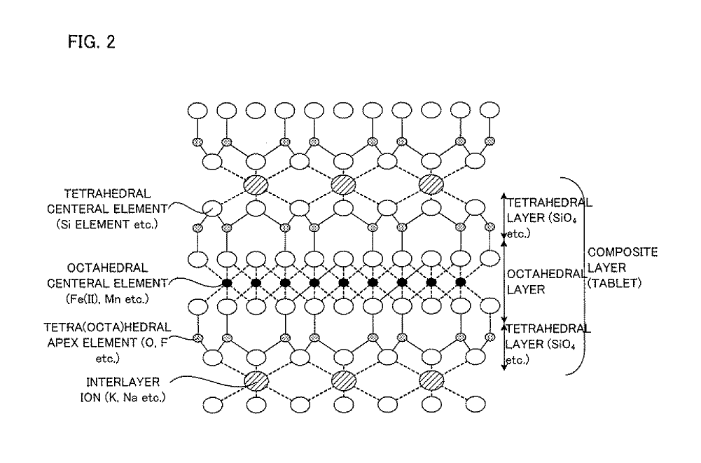

In general, a mica group mineral has a layered crystal structure. FIG. 2 is a schematic diagram illustrating an example of the crystal structure of a mica group mineral. As illustrated in FIG. 2, a mica group mineral has a tablet structure composed of a pair of tetrahedral layers and an octahedral layer, and cations (for example, K, Na, and Ca) are disposed between the tablet structures (between the layers). The tetrahedral layer contains Si element as the center of the tetrahedron, and contains O element as the apexes of the tetrahedron (and adjoining octahedrons). Incidentally, the Si element may be partially substituted by cations (for example, Al and Fe(III)), and the O element may be partially substituted by anions (for example, F and OH). The octahedral layer contains a cation (for example, a transition metal element such as Fe(II) or Mn) as the center of the octahedron.

Conventionally, for the purpose of synthesizing a compound having the same functionality as that of a mica group mineral, in the case of synthesizing a compound having the same structure as that of a mica group mineral, it is necessary to form a crystal structure such as described above. In order to obtain such a crystal structure, it is necessary to have a crystallization process for which strict control is required, and productivity is low. Examples of the crystallization process include a method of forming a vitreous compound, and then subjecting the compound to a heat treatment so as to crystallize the compound. On the contrary, the inventors of the present invention confirmed that a compound having the same composition as that of mica group minerals has the same functionality as that of mica group minerals, even if the compound does not have a crystal structure, that is, the compound is vitreous. Therefore, the present invention does not need to have a crystallization process such as described above, and has excellent productivity.

Furthermore, according to Patent Document 1 or the like, it is disclosed that mica group minerals enable insertion and desorption of conductive ions, and thus function as anode active materials. The detailed mechanism for the insertion and desorption of conductive ions in a mica group mineral is not clearly understood, but the mechanism is speculated to be as follows. That is, it is contemplated that insertion and desorption of conductive ions (for example, Li ions) occur between the elements that constitute a mica group mineral.

On the other hand, in the present invention, a vitreous anode active material having the composition of a mica group mineral can be obtained by heat treating a raw material mixture having a composition that is capable of forming a mica group mineral so as to form a raw material melt, and then cooling the raw material melt. Such a vitreous anode active material is sufficiently capable of insertion and desorption of conductive ions, and thus sufficiently functions as an anode active material. Here, the mechanism by which the vitreous anode active material allows the insertion and desorption of conductive ions is not clearly understood, but the mechanism is speculated to be as follows. That is, it is contemplated that since the anode active material is vitreous, gaps are generated between the atoms that constitute the anode active material, and as the anode active material has those gaps, it is easier for conductive ions to be inserted and desorbed.

Hereinafter, each step of the method for producing the anode active material of the present invention will be explained.

1. Heat Treatment Step

The heat treatment step according to the present invention is a step of heat treating a raw material mixture having a composition that is capable of forming a mica group mineral to form a raw material melt.

(1) Raw Material Mixture

The raw material mixture according to the present invention is not particularly limited as long as the raw material mixture has a composition that is capable of forming a mica group mineral. Furthermore, the raw material mixture is preferably a mixture that is capable of forming, for example, an anode active material represented by a general formula: XY₃ZSi₃O₁₀A₂.

The X element in the above general formula is not particularly limited as long as the X element represents at least one of K, Na, Ca, Li and Sr, and it is preferable that the X element contains at least K. The Y element is not particularly limited as long as the Y element represents at least one of Mg, Fe(II), Al and Li, but among others, it is preferable that the Y element contains at least one of Mg and Fe(II). The Z element is not particularly limited as long as the Z element represents at least one of Si, Al, Fe(III), Ge, Ga and B, but among others, it is preferable that the Z element contains at least one of Al and Fe(III). Furthermore, the A element is not particularly limited as long as the A element represents at least one of OH, F, Cl, O and S, and among others, it is preferable that the A element contains at least one of OH and F.

The raw material mixture can contain a combination of arbitrary elements selected among the elements described above as the X element, Y element, Z element and A element, respectively. Among them, a raw material mixture containing Mg as the Y element and Fe(III) as the Z element, or a raw material mixture containing Fe(II) as the Y element and Al as the Z element is particularly preferred. An example of the raw material mixture containing Mg as the Y element and Fe(III) as the Z element may be a raw material mixture that is capable of forming an anode active material represented by a general formula: KMg₃FeSi₃O₁₀F₂. Furthermore, another example of the raw material mixture containing Fe(II) as the Y element and Al as the Z element may be a raw material mixture that is capable of forming an anode active material represented by a general formula: KFe₃AlSi₃O₁₀F₂.

When the raw material mixture contains Fe(III) as the Z element, the proportion of Fe(III) in the entire amount of the Z element is, for example, preferably 0.1 mol % or greater, more preferably 20 mol % or greater, and particularly preferably 50 mol % or greater. Furthermore, it is also acceptable that the entirety of the Z element in the general formula be Fe(III).

When the raw material mixture contains Fe(II) as the Y element, the proportion of Fe(II) in the entire amount of the Y element is, for example, preferably 0.1 mol % or greater, more preferably 20 mol % or greater, and particularly preferably 50 mol % or greater. Furthermore, it is also acceptable that the entirety of the Y element in the general formula be Fe(II).

The raw material mixture according to the present invention is not particularly limited as long as the raw material mixture has a composition that is capable of forming a mica group mineral, and specifically, a raw material mixture having a composition that is capable of forming black mica (general formula: K(Mg, Fe(II))₃ZSi₃O₁₀A₂ (wherein Z represents Al and/or Fe(III), and A represents OH and/or F)), iron mica (general formula: KFe₃AlSi₃O₁₀(OH,F)₂), or the like can be used.

The raw material mixture according to the present invention can be obtained by, for example, mixing a plural number of raw materials that become the X element source, Y element source, Z element source, Si element source, and A element source in the above general formula. The respective element sources are not particularly limited as long as the element sources contain the respective elements, but examples thereof include oxides, hydroxides, fluorides, chlorides, sulfides, and carbonates.

Regarding the method for mixing plural raw materials that serve as the element sources described above, there are no particular limitations as long as the method is a method capable of sufficiently mixing the raw materials, and examples thereof include a mortar mixing method, a ball mill mixing method, and a stirring mixing method.

The mixing method described above may be a dry method only or may be a wet method only, but it is preferable to carry out a dry method and a wet method in combination. It is because, for example, raw materials can be prevented from adhering to the wall surface of the container used at the time of mixing or the like, and as compared with the embodiment of mixing only by a dry method and the embodiment of mixing only by a wet method, a satisfactory mixed state can be obtained. Furthermore, in the present invention, it is preferable that a dry method and a wet method be carried out in this order. Incidentally, the solvent that is used in a wet method is not particularly limited as long as the solvent does not deteriorate the raw materials described above, and examples thereof include alcohols such as ethanol, and non-aqueous polar solvents.

(2) Raw Material Melt

The raw material melt according to the present invention is formed by heat treating the raw material mixture described above.

The temperature at which the raw material mixture described above is heat treated (heat treatment temperature) is not particularly limited as long as the temperature is a temperature at which a desired anode active material may be obtained, and for example, the temperature can be adjusted to a temperature higher than or equal to the temperature at which the raw material mixture melts. The heat treatment temperature can be appropriately set according to, for example, the composition of the mica group mineral carried by the raw material mixture, that is, the desired composition of the anode active material. Specifically, the heat treatment temperature is preferably 1100° C. or higher, more preferably 1250° C. or higher, and particularly preferably 1300° C. or higher.

The heat treatment time according to the present invention is not particularly limited as long as the time is long enough to obtain a homogeneous raw material melt, and the heat treatment time can be appropriately set according to the composition of the raw material mixture or the like. The time is preferably, for example, 2 hours or longer. It is because if the heat treatment time is shorter than the range described above, there is a possibility that a sufficiently homogeneous raw material melt may not be obtained.

The atmosphere for heat treatment step can be appropriately selected according to the composition of the mica group mineral contained in the raw material mixture, or the like. Specifically, when the raw material mixture contains Fe(III), for example, an air atmosphere may be used. Furthermore, when the raw material mixture contains Fe(II), for example, an atmosphere which does not contain oxygen (for example, an inert atmosphere) is preferred. It is because when an atmosphere containing oxygen is used, Fe(II) is oxidized, and there is a possibility that it may become difficult to obtain a desired anode active material. In addition, the heating method according to the present invention is not particularly limited as long as the method is a method capable of imparting a desired temperature.

2. Cooling Step

Next, the cooling step according to the present invention will be explained. The cooling step according to the present invention is a step of cooling the raw material melt described above to vitrify the raw material melt. Thereby, a vitreous anode active material having the composition of a mica group mineral can be obtained.

Regarding the method for cooling the raw material melt according to the present invention, there are no particular limitations as long as the method is a method capable of cooling the raw material melt obtained in the heat treatment step to vitrify the raw material melt. Such a cooling method is appropriately selected according to the composition of the raw material melt, i.e., the composition carried by the raw material mixture described above or the like, but for example, a method of cooling the raw material melt, and bringing the raw material melt into contact with a cooling medium at a temperature as low as to the extent that the raw material melt can be cooled and vitrified, may be used. Examples of the cooling medium that can be used include water, ice water, and a cooling roll. Incidentally, if a vitreous anode active material can be obtained, the cooling method may be indoor natural cooling (excore cooling). Also, the cooling time is appropriately set according to the composition of the raw material melt, that is, the composition carried by the raw material mixture described above, and the like.

3. Anode Active Material

The anode active material obtained by the present invention is not particularly limited as long as it is a vitreous anode active material which is obtainable by the heat treatment step and the cooling step described above and has the composition of a mica group mineral. Among others, the anode active material is preferably a material represented by a general formula: XY₃ZSi₃O₁₀A₂. In regard to such an anode active material, detailed description will be given in the section “B. Anode active material”

B. Anode Active Material

Next, the anode active material of the present invention will be described. The anode active material of the present invention is a vitreous anode active material represented by a general formula: XY₃ZSi₃O₁₀A₂, wherein the X element represents at least one of K, Na, Ca, Li and Sr; the Y element represents at least one of Mg, Fe(II), Al and Li; the Z element represents at least one of Si, Al, Fe(III), Ge, Ga and B; and the A element represents at least one of OH, F, Cl, O and S.

According to the present invention, the anode active material has a composition represented by the above general formula, is vitreous, and allows insertion and desorption of conductive ions (for example, Li ions), the anode active material functions as an anode active material. Examples of such a composition include the compositions of black mica (general formula: KMg₃FeSi₃O₁₀F₂ (Fe(III)-substituted type)) and iron mica (general formula: KMg₃FeSi₃O₁₀F₂ (Fe(II)-substituted type)) described above.

Here, the term “being vitreous” as used in the present invention means that the material has a halo peak having a half value width of 4° or greater in an analysis by X-ray diffraction (XRD) using CuKα radiation. A halo peak can be observed usually in the case where in a compound to be subjected to an XRD analysis, the atoms that constitute the compound are disorderly arranged. Furthermore, in the present invention, it is preferable that the peak top of the halo peak exist in the range of 2θ=25° to 30°.

The anode active material is not particularly limited as long as the material has the halo peak described above in an XRD analysis using CuKα radiation; however, a material in which, for example, a peak exhibiting the crystal phase of a spinel compound that contains at least one of the Y element and the Z element in the aforementioned general formula is not observed, is preferred. It is because the proportion of the crystal phase that is deposited as impurities within the anode active material can be sufficiently lowered. Furthermore, the anode active material may have, or may not have, a peak of the same crystal phase as that of a mica group mineral, as long as the material has the aforementioned halo peak.

Specifically, when the anode active material obtainable by the present invention is the Fe(III)-substituted type as described above, it is preferable that the anode active material have the halo peak described above in an XRD analysis using CuKα radiation and do not have a peak of an impurity phase (spinel type oxide having a Z element (Fe(III)), MgFe₂O₄) at the position of 2θ=35.6°±0.5°. Furthermore, in this case, the anode active material may have, or may not have, a peak of the same crystal phase as that of a mica group mineral (for example, a peak at 2θ=26.8°±0.5°) as long as the anode active material has the halo peak described above.

Furthermore, when the anode active material obtainable by the present invention is the Fe(II)-substituted type as described above, it is preferable that the anode active material have the halo peak described above in an XRD analysis using CuKα radiation and do not have a peak of an impurity phase (spinel type oxide having a Y element (Fe(II)), MgFe₂O₄) observed at the position of 2θ=35.6°±0.5°. Furthermore, in this case, the anode active material may have, or may not have, a peak of the same crystal phase as that of a mica group mineral as long as the anode active material has the halo peak described above.

Furthermore, it is preferable that the anode active material have a vitreous phase as the main phase, and above all, it is more preferable that the proportion of the crystal phase in the anode active material be 0.

Examples of the shape of the anode active material include a particulate shape and a thin film shape. Furthermore, when the anode active material has a particulate shape, the average particle size thereof is preferably in the range of, for example, 0.1 μm to 50 μm.

Furthermore, in the present invention, a battery which is characterized by using the anode active material described above can be provided. The battery is not particularly limited as long as the battery comprises a cathode layer containing a cathode active material, an anode layer containing an anode active material, and an electrolyte layer that is formed between the cathode layer and the anode layer. Regarding the configuration of the battery, a configuration that is used in common batteries can be used.

The battery is selected according to the kind of the X element and the like in the raw material mixture described above, and examples include a lithium battery, a sodium battery, a magnesium battery, and a calcium battery. Furthermore, a battery that is produced using the anode active material of the present invention may be a primary battery, or may be a secondary battery; however, above all, the battery is preferably a secondary battery. It is because a secondary battery is capable of repeated charging and discharging, and is therefore useful as, for example, a battery for vehicle installation. Incidentally, the primary battery refers to, for example, a battery which is capable of utilization as a primary battery, that is, a battery which is first subjected to charging and then is subjected to discharging. Examples of the shape of such a battery include a coin-shaped form, a laminated form, a cylindrical form, and a box-shaped form, and among them, a box-shaped form and a laminated form are preferred, while a laminated form is particularly preferred.

Incidentally, the present invention is not intended to be limited to the embodiments described above. The embodiments are only for illustrative purposes, and any embodiment which has a configuration that is substantially the same as the technical idea described in the claims of the present invention and gives the same operating effect, is to be included in the technical scope of the present invention.

### EXAMPLES

The present invention will be more specifically described by way of Examples described below.

### Example 1

### Synthesis of Anode Active Material

Starting raw materials shown below were provided.
Silicon dioxide (SiO₂, Wako Pure Chemical Industries, Ltd.)
Magnesium oxide (MgO, Wako Pure Chemical Industries, Ltd.)
Iron(III) oxide (Fe₂O₃, Wako Pure Chemical Industries, Ltd.)
Potassium fluoride (KF, Wako Pure Chemical Industries, Ltd.)
Magnesium fluoride (MgF₂, Wako Pure Chemical Industries, Ltd.)

The starting raw materials were weighed such that the composition of the raw material mixture would be KMg₃FeSi₃O₁₀F₂. The starting raw materials were introduced into an agate mortar and the mixture was mixed by a dry method for 5 minutes and then was further mixed by a wet method (solvent: ethanol) for 5 minutes. Thus, a raw material mixture was obtained. Next, 1 g of the raw material mixture was molded by isostatic pressing (CIP) at a pressure of 150 MPa, and the molded product was dried. The raw material mixture was filled in a platinum container, the container was sealed, and the raw material mixture was heat treated in an air atmosphere under the conditions of 1350° C. for 2 hours. Thus, a mixed melt was formed. Thereafter, the mixed melt was left to cool indoors (excore cooling), and thus a vitreous anode active material was obtained.

### Examples 2 and 3

An anode active material was obtained in the same manner as in Example 1, except that the temperature at which the raw material mixture was heat treated was changed to 1320° C.

### Example 4

Starting raw materials shown below were provided.
Silicon dioxide (SiO₂, Wako Pure Chemical Industries, Ltd.)
Aluminum oxide (Al₂O₃, Wako Pure Chemical Industries, Ltd.)
Iron(II) oxide (FeO, Sigma-Aldrich Co. LLC.)
Potassium fluoride (Kr, Wako Pure Chemical Industries, Ltd.)
Iron(II) fluoride (FeF₂, Wako Pure Chemical Industries, Ltd.)

The starting raw materials were weighed such that the composition of the raw material mixture would be KFe₃AlSi₃O₁₀F₂. The starting raw materials were introduced into an agate mortar and the mixture was mixed by a dry method for 5 minutes and then was further mixed by a wet method (solvent: ethanol) for 5 minutes. Thus, a raw material mixture was obtained. Next, 1 g of the raw material mixture was molded by isostatic pressing (CIP) at a pressure of 150 MPa, and the molded product was dried. The raw material mixture was filled in a platinum container, the container was sealed, and the raw material mixture was heat treated in an inert atmosphere under the conditions of 1300° C. for 2 hours. Thus, a mixed melt was formed. Thereafter, the mixed melt was left to cool indoors (excore cooling), and thus a vitreous anode active material was obtained.

[Evaluation 1]

(X-Ray Diffraction Analysis)

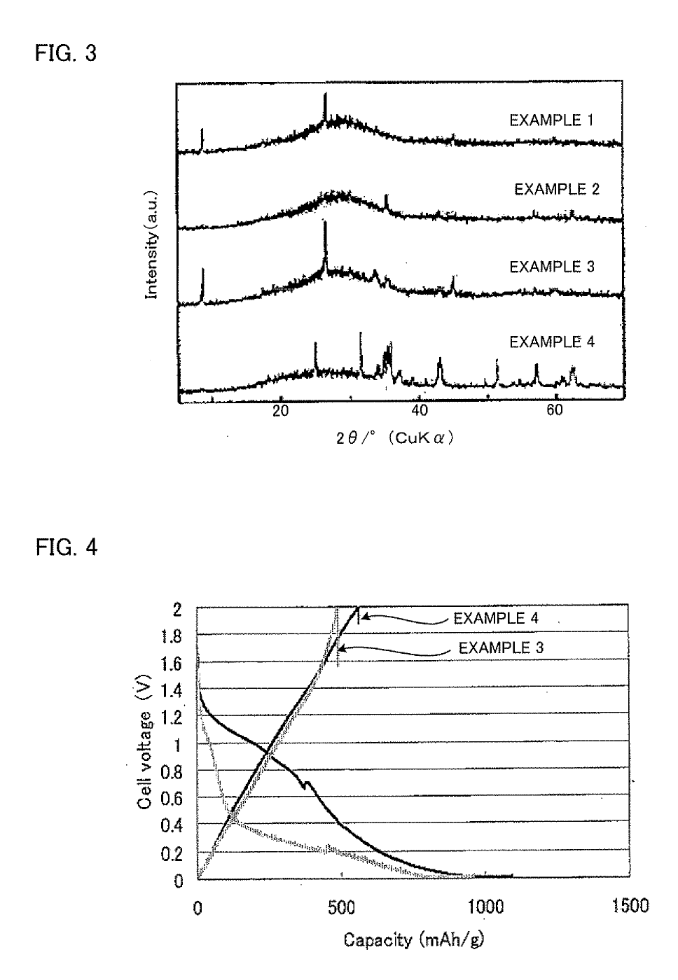

An X-ray diffraction (XRD) analysis using CuKα radiation was carried out using the anode active materials obtained in Examples 1 to 4. The results are presented in FIG. 3. As shown in FIG. 3, it was confirmed that all of Examples 1 to 4 had a halo peak having a half value width of 4° or greater. Furthermore, it was confirmed that all of Examples 1 to 4 had a peak top of the halo peak in the range of 2θ=25° to 30°. Thereby, it was confirmed that the anode active materials obtained in Examples 1 to 4 were vitreous.

Furthermore, in Examples 1 to 3, no peak of an impurity phase (spinel type oxide, MgFe₂O₄) was confirmed at the position of 2θ=35.6°±0.5°. Incidentally, in Examples 1 and 3, a peak of the same crystal phase as that of a mica group mineral was confirmed at the position of 26.8°±0.5°; however, in Example 2, the peak of the crystal phase was not confirmed. Also, in Example 4, a peak of an impurity phase (spinel type oxide, FeAl₂O₄) at the position of 2θ=35.6°±0.5° was not confirmed.

[Evaluation 2]

(Battery Production)

Batteries for evaluation were produced using the anode active materials obtained in Examples 3 and 4, and an evaluation of the battery characteristics was carried out. First, 0.160 g of a polyimide binder precursor (manufactured by Toray Industries, Inc.) having a solid content of 15% and 0.285 g of NMP as a solvent were sealed in an ointment container, a magnetic stirrer tip was introduced thereinto, and then the mixture was stirred for 5 minutes using a stirrer. Next, a conductive aid HS-100 was added to the mixture, and the resulting mixture was stirred for another 5 minutes. Subsequently, the anode active materials obtained in Examples 3 and 4 were each classified with a 40-μm mesh screen. To the mixture, 0.250 g of each of the anode active materials obtained after classification was added, and the resulting mixture was mixed for 10 minutes to prepare a slurry. Incidentally, the weight ratio of the anode active material, binder and conductive aid was anode active material:binder:conductive aid=64:6:30.

Next, a copper foil was provided as a current collector. Thereafter, the slurry was applied on the surface of the copper foil by a doctor blade method, and the copper foil was subjected to pressing three times by a roll pressing method. Subsequently, the temperature was increased at a rate of 5° C./min under an argon (Ar) gas stream, and the current collector was retained at 350° C. for 2 hours, to thereby heat treat the binder. Thereafter, the current collector was punched to obtain a circle having a diameter of 16 mm, and thus a test electrode was obtained. A coin cell was used, the aforementioned test electrode was used as a working electrode, Li metal was used as a counter electrode, and a separator made of polyethylene was employed as a separator. Furthermore, as a liquid electrolyte, a solution obtained by dissolving supporting salt LiPF₆ at a concentration of 1 mol/L in a solvent prepared by mixing ethylene carbonate (EC), ethyl methyl carbonate (EMC) and dimethyl carbonate (DMC) at a volume ratio of EC:EMC:DMC=3:4:3, was used. A battery for evaluation was obtained using these. Incidentally, in a coin cell, since the lower can unit could be distorted by caulking, a spacer having a thickness of 0.5 mm was inserted between the working electrode and the counter electrode.

(Evaluation of Initial Charge-Discharge Properties)

The batteries for evaluation containing the anode active materials obtained in Examples 3 and 4 were used to perform an evaluation of the initial charge-discharge properties at 60° C. Incidentally, the charge-discharge conditions were as follows:

Charge potential: 0.01 V, current value: 0.1 C (a capacity of 1 C was calculated from 1000 mAh/g per active material), Cut: 0.02 mA

Discharge potential: 2.0 V, current value: 0.1 C.

The results are presented in FIG. 4 and Table 1. From the results of FIG. 4 and Table 1, it was confirmed that insertion and desorption of Li ions had occurred similarly to the case of mica group minerals. Therefore, it was confirmed that a vitreous compound having the same composition as that of a mica group mineral can function as an anode active material.

TABLE 1

| | Initial Li | Initial Li |
|---|---|---|
| | desorption capacity | insertion capacity |
| | (mAh/g) | (mAh/g) |
| Example 3 | 459.1 | 907.1 |
| (Fe(III)- | | |
| substituted type) | | |
| Example 4 | 549.7 | 1074.4 |
| (Fe(II)- | | |
| substituted type) | | |

Furthermore, it was confirmed that the initial Li desorption capacity of graphite that is generally widely used as an anode active material was about 350 mAh/g, and the initial Li desorption capacities of the anode active materials obtained in the present invention were higher.

(Evaluation of Cycle Characteristics)

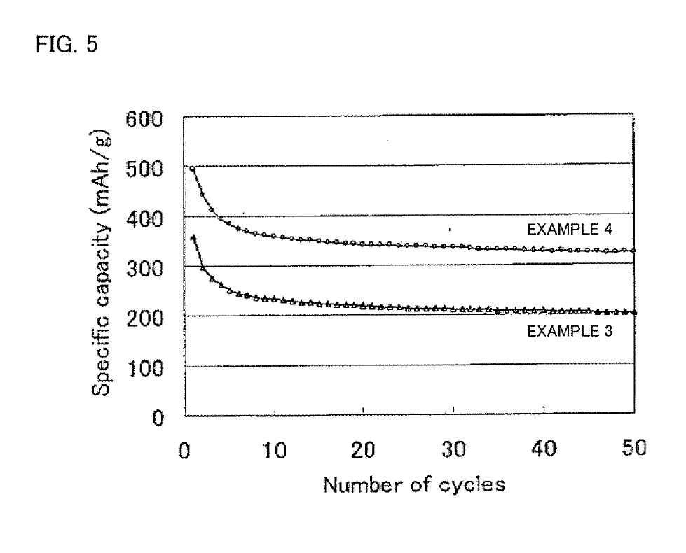

The cycle characteristics at 25° C. were evaluated using the batteries for evaluation containing the anode active materials obtained in Examples 3 and 4. Incidentally, regarding the charge-discharge conditions, charging and discharging was carried out in the same manner as in the evaluation for the charge-discharge properties, and charging and discharging was repeated 50 times. The results are presented in FIG. 5. As shown in FIG. 5, it was confirmed that all of the batteries for evaluation had a decrease in capacity up to about the 10^{th} cycle, but the capacities were stabilized thereafter.

What is claimed is:

1. A method for producing a vitreous anode active material, the method comprising steps of:
a heat treatment step of heat treating a raw material mixture having a composition that is capable of forming a mica group mineral, and thereby forming a raw material melt; and
a cooling step of cooling the raw material melt, and thereby vitrifying the raw material melt.

2. The method for producing a vitreous anode active material according to claim 1,
wherein the raw material mixture is capable of forming an anode active material represented by a general formula: XY₃ZSi₃O₁₀A₂,
the X element represents at least one of K, Na, Ca, Li and Sr;
the Y element represents at least one of Mg, Fe(II), Al and Li;
the Z element represents at least one of Si, Al, Fe(III), Ge, Ga and B; and
the A element represents at least one of OH, F, Cl, O and S.

3. The method for producing a vitreous anode active material according to claim 1, wherein in the heat treatment step, the raw material mixture is mixed by both of a dry method and a wet method.

4. The method for producing a vitreous anode active material according to claim 1, wherein a temperature at which the raw material mixture is heat treated is 1100° C. or higher.

5. A vitreous anode active material represented by a general formula: XY₃ZSi₃O₁₀A₂,
wherein the X element represents at least one of K, Na, Ca, Li and Sr;
the Y element represents at least one of Mg, Fe(II), Al and Li;
the Z element represents at least one of Si, Al, Fe(III), Ge, Ga and B; and
the A element represents at least one of OH, F, Cl, O and S.
